(19) United States
(12) Patent Application Publication
(10) Pub. No.: US 2026/0062575 A1
(43) Pub. Date: Mar. 5, 2026

(54) Ink Set And Recording Method

(71) Applicant: SEIKO EPSON CORPORATION, Tokyo (JP)

(72) Inventors: Hiromi NOGUCHI, Shiojiri (JP); Masashi IGARASHI, Shiojiri (JP)

(21) Appl. No.: 19/318,856

(22) Filed: Sep. 4, 2025

(30) Foreign Application Priority Data
Sep. 5, 2024 (JP) 2024-153146

(51) Int. Cl. C09D 11/324

(52) U.S. Cl. CPC C09D 11/324

(57) ABSTRACT

An ink set according to an embodiment of the present disclosure includes a white ink composition containing a white color material and a non-white ink composition containing a non-white color material, and is used for recording on a low-absorptive recording medium or a non-absorptive recording medium, in which the white ink composition and the non-white ink composition are aqueous ink jet inks, and the white ink composition contains a polyether-modified silicone-based surfactant having a weight average molecular weight Mw of 2,000 or less.

The present application is based on, and claims priority from JP Application Serial Number 2024-153146, filed Sep. 5, 2024, the disclosure of which is hereby incorporated by reference herein in its entirety.

### BACKGROUND

### 1. Technical Field

The present disclosure relates to an ink set and a recording method.

### 2. Related Art

Ink jet recording methods can record high-definition images with a relatively simple device, and achieve rapid development in various fields. Among these, in order to obtain favorable visibility of a color image (non-white image) even when recording on a recording medium such as a transparent film, stacking and applying a white ink composition (hereinafter, also referred to as “white ink”) and a non-white ink composition (hereinafter, also referred to as “color ink”) is performed.

For example, JP-A-2022-025233 discloses an ink jet recording method in which a white ink composition and a non-white ink composition are overlaid and adhered to a low-absorptive recording medium or a non-absorptive recording medium.

However, when recording is performed by overlaying the color ink on the white ink, unevenness of the color image (non-white image) occurs due to insufficient embedment of the white ink on the recording medium.

### SUMMARY

According to an aspect of the present disclosure, there is provided an ink set including: a white ink composition containing a white color material; and a non-white ink composition containing a non-white color material, in which the ink set is used for recording on a low-absorptive recording medium or a non-absorptive recording medium, the white ink composition and the non-white ink composition are aqueous ink jet inks, and the white ink composition contains a polyether-modified silicone-based surfactant having a weight average molecular weight Mw of 2,000 or less.

According to another aspect of the present disclosure, there is provided a recording method using the ink set according to the above aspect, the recording method including: a white ink adhesion step of adhering the white ink composition to a recording medium by an ink jet method; and a non-white ink adhesion step of adhering the non-white ink composition to the recording medium by an ink jet method, in which the recording medium is a low-absorptive recording medium or a non-absorptive recording medium.

### BRIEF DESCRIPTION OF THE DRAWINGS

FIG. 1 is a schematic cross-sectional view schematically illustrating an ink jet recording device.

FIG. 2 is a perspective view illustrating an example of a configuration around a carriage of an ink jet recording device.

FIG. 3 is a view illustrating a composition example of a white ink composition (Table 1).

FIG. 4 is a view illustrating a composition example of a non-white ink composition (Table 2).

FIG. 5 is a view illustrating each example, each comparative example and reference example, and an evaluation result (Table 3).

### DESCRIPTION OF EMBODIMENTS

Hereinafter, embodiments of the present disclosure will be described. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

In the present specification, a numerical range indicated by using “to” means a range including numerical values described before and after “to” as a lower limit value and an upper limit value.

In the present specification, “(meth)acrylic” means acrylic or methacrylic, and “(meth)acrylate” means acrylate or methacrylate.

### 1. Ink Set

According to an embodiment of the present disclosure, there is provided an ink set including a white ink composition containing a white color material and a non-white ink composition containing a non-white color material, in which the ink set is used for recording on a low-absorptive recording medium or a non-absorptive recording medium, the white ink composition and the non-white ink composition are aqueous ink jet inks, and the white ink composition contains a polyether-modified silicone-based surfactant having a weight average molecular weight Mw of 2,000 or less.

In the present case, when the color ink was overlaid on the white ink to perform recording, unevenness of the color image (non-white image) occurred. The unevenness occurred when the white ink was stored for a long period of time, and did not occur when the white ink was not stored for a long period of time.

As a result of the study, it was found that the white ink after long-term storage has a decreased wet spreadability with respect to the recording medium, and the white ink is insufficiently embedded on the recording medium. The white ink insufficiently embedded and unevenly adhered on the recording medium has uneven wet spreadability of the color ink overlaid and adhered on the white ink, and as a result, unevenness of the color image occurred.

Further studies revealed that the content of the silicone-based surfactant contained in the white ink was reduced after long-term storage as compared with the time of manufacturing. It is presumed that this is because the silicone-based surfactant is hydrolyzed by water during long-term storage.

Therefore, by using a polyether-modified silicone-based surfactant having a weight average molecular weight Mw of a predetermined value or less, which is less likely to undergo hydrolysis, the embedment of the white ink on the recording medium could be made favorable and, as a result, the occurrence of unevenness of the color image could be reduced.

In the present disclosure, the “ink set” is at least a set of inks in which a white ink composition and a non-white ink composition are combined. The ink set is a set of inks used for recording. The non-white ink composition included in the ink set may be only one or may be two or more. The same applies to the white ink composition included in the ink set.

### 1.1. White Ink Composition

An ink set according to the present embodiment includes a white ink composition containing a white color material, in which the white ink composition is an aqueous ink jet ink, and contains a polyether-modified silicone-based surfactant having a weight average molecular weight Mw of 2,000 or less.

Hereinafter, each component contained in the white ink composition will be described.

### 1.1.1. White Color Material

The white ink composition contains a white color material.

Examples of the white color material include C. I. Pigment White 1, which is basic zinc carbonate, C. I. Pigment White 4 made of zinc oxide, C. I. Pigment White 5 made of a mixture of zinc sulfide and barium sulfate, C. I. Pigment White 6 made of titanium dioxide, C. I. Pigment White 6:1 made of titanium dioxide containing other metal oxides, C. I. Pigment White 7 made of zinc sulfide, C. I. Pigment White 18 made of calcium carbonate, C. I. Pigment White 19 made of clay, C. I. Pigment White 20 made of mica titanium, C. I. Pigment White 21 made of barium sulfate, C. I. Pigment White 22 made of gypsum, C. I. Pigment White 26 made of magnesium oxide and silicon dioxide, C. I. Pigment White 27 made of silicon dioxide, C. I. Pigment White 28 made of anhydrous calcium silicate, and the like. Among these, C. I. Pigment White 6 which is excellent in color development properties, masking properties, and the like is preferably used.

In addition, particles having a hollow structure may be used as the white color material, and known particles can be used, as the particles having a hollow structure.

A volume average particle diameter of the white color material is preferably 30 nm or more and 500 nm or less, more preferably 50 nm or more and 450 nm or less, and further more preferably 200 nm or more and 400 nm or less.

By setting the volume average particle diameter of the white color material in this range, there is a tendency that ejection stability from an ink jet head can be ensured. In addition, there is a tendency that the masking properties can be improved.

Furthermore, in the present specification, the “volume average particle diameter” refers to a volume-based particle size distribution, which is a particle diameter at 50% by volume cumulative distribution, unless otherwise specified. The volume average particle diameter is measured by a dynamic light scattering method or a laser diffraction light method described in JIS Z8825. Specifically, a particle size analyzer (for example, “Microtrac UPA” manufactured by Nikkiso Co., Ltd.) using the dynamic light scattering method as a measurement principle can be used.

In the present specification, the term “white” when referring to a white ink composition, a white color material, and the like does not mean only completely white, but as long as the color is in a range of being visually recognized as white, the white includes color that is colored with chromatic color or achromatic color, or color having glossiness. In addition, the name of the ink or color material includes those that suggest that the ink or color material is white and those that are named and sold.

More quantitatively, the “white” in a recorded matter includes not only a color in which L* is 100, but also a color in which L* is 60 or more and 100 or less and a* and b* each are ±10 or less, in CIELAB, for example.

More specifically, when lightness (L*) and chromaticity (a*, b*) of a recording portion of a recorded matter are measured using a CIELAB-compliant spectrophotometer when recording is performed in such an amount that a surface of a recording medium made of a transparent film is sufficiently covered with the ink, the white ink composition preferably falls within the above range. The recorded matter recorded in a sufficiently covered amount is, for example, an adhesion amount of 15 mg/inch². More preferably, 80≤L*≤100, −4.5≤a*≤2, and −10≤b*≤2.5. Examples of the recording medium made of a transparent film include LAG Jet E-1000ZC (manufactured by LINTEC Corporation). Examples of the CIELAB-compliant spectrophotometer include SPECTROLINO (product name, manufactured by GretagMacbeth), where measurement is performed by setting measurement conditions as D50 light source, observation field as 2°, concentration as DIN NB, white standard as Abs, filter as No, and measurement mode as Reflectance.

In addition, a color other than “white” is referred to as “non-white”.

A content of the white color material is preferably 1% to 30% by mass, more preferably 2% to 25% by mass, further more preferably 4% to 20% by mass, particularly preferably 6% to 15% by mass, and more particularly preferably 8% to 12% by mass, with respect to a total amount of the white ink composition. When the content of the white color material is within the range, there is a tendency that rubbing fastness can be made more favorable and more favorable color development properties (whiteness) can be obtained.

In order to enhance the dispersibility of the white color material in the ink composition, it is preferable to perform a surface treatment on the color material or to blend a dispersant or the like.

A surface treatment of the white color material is preferably a treatment to directly or indirectly bond a carbonyl group, a carboxyl group, an aldehyde group, a hydroxyl group, a sulfone group, an ammonium group, a functional group formed of salts thereof, or the like to a surface of the color material by physical or chemical treatment. In particular, the surface treatment is more preferably a treatment in which the surface of the color material is oxidized or sulfonated with, for example, ozone, hypochlorous acid, fuming sulfuric acid, or the like to modify the surface of the color material.

When a dispersant is blended in the white ink composition, a dispersant having a hydrophobic portion (hydrophobic group) and a hydrophilic portion (hydrophilic group) in the molecular structure are preferably used. In such a dispersant, the hydrophobic portion has an action of being adsorbed on a particle surface of the color material, and the hydrophilic portion has an action of being oriented on an aqueous medium side of the ink composition. Due to the action, there is a tendency that the color material can be more stably contained in the ink composition as a dispersant.

Such a dispersant is not particularly limited, and examples thereof include styrene-acrylic resin such as an acrylic resin, a styrene-(meth)acrylic acid copolymer, and a styrene-(meth)acrylic acid-(meth)acrylate copolymer, a styrene-maleic acid-based resin, salts thereof, formalin condensates of aromatic sulfonate, and the like, and one or more selected from these groups can be adopted. A commercially available product may be used as the dispersant.

When the white color material is dispersed by a dispersant, a ratio of the white color material to the dispersant is preferably 10:1 to 1:10, and more preferably 4:1 to 1:3.

In addition, a method of coating the particles of the white color material with a resin or the like to impart dispersibility may be used. As a method of coating the white color material, an acid analysis method, a phase inversion emulsification method, a mini-emulsion polymerization method, and the like can be adopted.

### 1.1.2 Specific Polyether-Modified Silicone-Based Surfactant

The white ink composition contains a polyether-modified silicone-based surfactant (hereinafter, also referred to as “specific polyether-modified silicone-based surfactant”) having a weight average molecular weight Mw of 2,000 or less.

When such a specific polyether-modified silicone-based surfactant is used, it is presumed that water molecules can be prevented from approaching polydimethylsiloxane skeleton that is easily cut by hydrolysis due to steric hindrance of a high-volume polyether-modified group. That is, it is presumed that when a length of the polydimethylsiloxane skeleton is shorter and a molecular weight is smaller, the approach of water molecules can be more sufficiently suppressed by the steric hindrance of the polyether-modified group. Therefore, it is presumed that when the specific polyether-modified silicone-based surfactant has a smaller molecular weight, the hydrolysis can be reduced, and the embedment of the white ink on the recording medium can be made favorable even after long-term storage.

The weight average molecular weight Mw of the specific polyether-modified silicone-based surfactant is 2,000 or less, preferably 1,800 or less, more preferably 1,600 or less, and even more preferably 1,500 or less. A lower limit of the weight average molecular weight Mw is not particularly limited, but is preferably 500 or more, more preferably 1,000 or more, and even more preferably 1,200 or more.

The weight average molecular weight Mw is preferably measured by gel permeation chromatography (GPC).

For example, the weight average molecular weight Mw is represented as a maximum peak in a range of a molecular weight of 300 or more in the molecular weight distribution in GPC.

The maximum peak in the range of such a molecular weight of 300 or more can be specified from a chart of the molecular weight distribution in GPC obtained by using the horizontal axis as the “logarithmic value of molecular weight M (Log M)” and the vertical axis as the “differential value (dw/d (Log M)) of the concentration fraction”. In addition, the term “maximum peak” means the maximum peak (mountain) in the range of a molecular weight of 300 or more. In addition, the “maximum peak in the range of a molecular weight of 300 or more” means that the peak having a molecular weight of less than 300 is ignored. That is, the maximum peak may be present at a molecular weight of less than 300, but is the maximum peak when viewed in the range of a molecular weight of 300 or more.

Although not particularly limited, for example, the measurement conditions in the GPC measurement in the present embodiment can be the conditions described in the examples described later, and the specific determination of the molecular weight can be performed using standard polystyrene.

The specific polyether-modified silicone-based surfactant may be more preferably both-end-modified polyether-modified silicone-based surfactant. The both-end-modified polyether-modified silicone-based surfactant is a polyether-modified silicone-based surfactant having a polyether-modified group at both ends of a polydimethylsiloxane skeleton.

In particular, the surfactant is more preferably a polyether-modified silicone-based surfactant represented by Formula (1). In such a case, when the surfactant is a polyether-modified silicone-based surfactant, the surfactant has a structure in which both ends are modified, and thus it is presumed that the high-volume polyether-modified group can cover the short-length polydimethylsiloxane skeleton from both sides and the water molecules can be made less likely to approach. As a result, there is a tendency that the hydrolysis of the polydimethylsiloxane skeleton can be further reduced, and the embedment of the white ink on the recording medium can be made more favorable even after long-term storage.

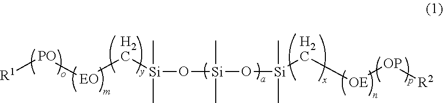

In the formula, a is an integer of 1 to 30, x and y are each independently an integer of 1 to 4, m and n are each independently an integer of 1 to 20, o and p are each independently an integer of 0 to 20, m*n is 2 to 40, o*p is 0 to 40, and R¹ and R² are each independently selected from the group consisting of a hydrogen atom, a hydroxy group, an alkyl group having 1 to 6 carbon atoms, and a (meth)acrylic group. E is an ethylene group, and P is a propylene group. The order between the OE (EO) unit and the OP (PO) unit is not specified.

In Formula (1), a is an integer of 1 to 30, preferably 25 or less, more preferably 20 or less, further more preferably 2 to 17, still more preferably 5 to 15, and particularly preferably 7 to 13.

x and y are each independently an integer of 1 to 4, preferably 1 to 3, and more preferably 2 to 3.

m and n are each independently an integer of 1 to 20, preferably 2 to 15, more preferably 4 to 10, and further more preferably 5 to 8.

o and p are each independently an integer of 0 to 20, preferably 0 to 10, more preferably 0 to 5, further more preferably 0 to 3, particularly preferably 0 to 1, and more particularly preferably 0.

m*n is 2 to 40, preferably 4 to 30, more preferably 8 to 20, and further preferably 10 to 15.

o*p is 0 to 40, preferably 0 to 20, more preferably 0 to 10, further more preferably 0 to 3, particularly preferably 0 to 1, and more particularly preferably 0.

R¹ and R² are each independently selected from the group consisting of a hydrogen atom, a hydroxy group, an alkyl group having 1 to 6 carbon atoms, and a (meth)acrylic group, and are preferably a hydroxy group. The order between the OE (EO) unit and the OP (PO) unit is not specified, that is, when each of the OE (EO) unit and the OP (PO) unit has one or more, the order is not specified in units of one OE (EO) and one P (PO).

P is a propylene group, and examples thereof include a 1,2-propylene group and a 1,3-propylene group, and a 1,2-propylene group is preferable.

The specific polyether-modified silicone-based surfactant may be a side chain-modified polyether-modified silicone-based surfactant. The side chain-modified polyether-modified silicone-based surfactant is a polyether-modified silicone-based surfactant having a polyether-modified group in a side chain of a polydimethylsiloxane skeleton.

Among these, a silicone-based surfactant represented by Formula (2) may be used. Even with such a side chain-modified structure, it is presumed that the high-volume polyether-modified group can cover the short-length polydimethylsiloxane skeleton and make it difficult for water molecules to approach. As a result, there is a tendency that the hydrolysis of the polydimethylsiloxane skeleton can be further reduced, and the embedment of the white ink on the recording medium can be made more favorable even after long-term storage.

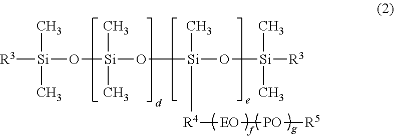

In the formula, R³ represents an alkyl group having 1 to 6 carbon atoms, respectively, R⁴ represents an alkylene group having 1 to 4 carbon atoms, R⁵ represents a group selected from the group consisting of a hydrogen atom, a hydroxy group, an alkyl group having 1 to 6 carbon atoms, and a (meth)acrylic group, EO represents an ethylene oxide group, PO represents a propylene oxide group, the order between EO units and PO units is not specified, d and e are integers of 1 or more, d+e represents an integer of 2 to 50, f is an integer of 1 to 20, and g is an integer of 0 to 20.

In Formula (2), d+e is an integer of 1 to 50, preferably 1 to 25, more preferably 1 to 20, further preferably 1 to 17, still further preferably 1 to 15, particularly preferably 1 to 13, and more particularly preferably 1 to 7.

d and e are preferably each half of d+e.

R⁴ is an alkylene group having 1 to 4 carbon atoms, preferably 1 to 3, and more preferably 2 to 3.

f is an integer of 1 to 20, preferably 2 to 15, more preferably 4 to 10, and still more preferably 5 to 8.

g is an integer of 0 to 20, preferably 0 to 10, more preferably 0 to 5, still more preferably 0 to 3, particularly preferably 0 to 1, and more particularly preferably 0.

R⁵ is selected from the group consisting of a hydrogen atom, a hydroxy group, an alkyl group having 1 to 6 carbon atoms, and a (meth)acrylic group, and is preferably a hydroxy group.

The specific polyether-modified silicone-based surfactant may be obtained by synthesis. For example, synthesis can be performed by an addition reaction of a silicone oil having a Si—H structure and a polyether having a carbon-carbon double bond at the terminal.

When the surfactant is a polyether-modified silicone-based surfactant of Formula (1), more specifically, it is preferable to synthesize the silicone oil represented by Formula (A) and the polyether represented by Formula (B) by an addition reaction using a Pt-based catalyst or the like. As a result, the polyether-modified silicone-based surfactant represented by Formula (1) can be preferably synthesized.

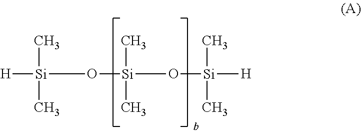

In the formula, b is an integer of 1 to 30.

b is a numerical value corresponding to a in Formula (1) of the obtained polyether-modified silicone-based surfactant, and may be a preferable range of a in Formula (1).

In Formula (A), b is an integer of 1 to 30, preferably 25 or less, more preferably 20 or less, further preferably 2 to 17, still more preferably 5 to 15, and particularly preferably 7 to 13.

When the surfactant is the polyether-modified silicone-based surfactant of Formula (2), more specifically, it is preferable to synthesize the polyether-modified silicone-based surfactant by performing an addition reaction of a silicone oil in which a portion of the polyether-modified group including R⁴ of Formula (2) is substituted with a hydrogen atom and a polyether represented by Formula (B) using a Pt-based catalyst or the like. In this case, the silicone oil also has a Si—H structure.

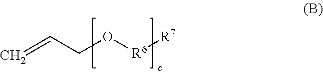

In the formula, c is an integer of 1 to 40, R⁶ represents an ethylene group or a propylene group, and R⁷ is selected from the group consisting of a hydrogen atom, a hydroxy group, an alkyl group having 1 to 6 carbon atoms, and a (meth)acrylic group.

In Formula (B), a portion of an allyl group of Formula (B) reacts with —H of Si—H of the silicone oil and becomes a portion of the polyether-modified group of Formula (1) or Formula (2).

When obtaining the silicone-based surfactant of Formula (1), a polyether of Formula (B) corresponding to the polyether-modified group of Formula (1) may be used. When obtaining the silicone-based surfactant of

Formula (2), a polyether of Formula (B) corresponding to the polyether-modified group of Formula (2) may be used.

In addition, c is preferably an integer of 1 to 20. When R⁶ is an ethylene group, c is preferably 2 to 15, more preferably 4 to 10, and further more preferably 5 to 8.

c is an integer of 1 to 20, but when R⁶ is a propylene group, c is preferably 1 to 10, more preferably 1 to 5, and still more preferably 1 to 3.

R⁶ is an ethylene group or a propylene group, and the ethylene group is preferable.

R⁷ is selected from the group consisting of a hydrogen atom, a hydroxy group, an alkyl group having 1 to 6 carbon atoms, and a (meth)acrylic group, and is preferably a hydroxy group.

A surface tension of a 0.1% by mass aqueous solution of the polyether-modified silicone-based surfactant having a weight average molecular weight Mw of 2,000 or less is preferably 28 mN/m or less, more preferably 26 mN/m or less, even more preferably 24 mN/m or less, and particularly preferably 23.5 mN/m or less. The lower limit of the surface tension is not particularly limited, but is preferably 15 mN/m or more, more preferably 17 mN/m or more, and even more preferably 20 mN/m or more.

When the ink is stored for a long period of time, the silicone-based surfactant decreases by hydrolysis and the embedment tends to deteriorate. However, when the silicone-based surfactant has the above range of surface tension, the wet spreadability of the ink is excellent and the embedment of the ink tends to be more excellent, even after particularly long-term storage.

A content of the specific polyether-modified silicone-based surfactant is preferably 0.05% to 2.0% by mass with respect to a total amount of the white ink composition. In this case, embedment of the white ink on the recording medium can be made more favorable, and as a result, the occurrence of unevenness of a color image can be reduced.

A lower limit of the content is preferably 0.05% by mass or more, more preferably 0.10% by mass or more, further more preferably 0.15% by mass or more, particularly preferably 0.20% by mass or more, more particularly preferably 0.25% by mass or more, and particularly preferably 0.30% by mass or more, with respect to the total amount of the white ink composition.

An upper limit of the content is preferably 2.0% by mass or less, more preferably 1.5% by mass or less, still more preferably 1.0% by mass or less, particularly preferably 0.70% by mass or less, more particularly preferably 0.50% by mass or less, and still more particularly preferably 0.40% by mass or less, with respect to the total amount of the white ink composition.

### 1.1.3 Water

The white ink composition is an aqueous ink jet ink. “Aqueous” means that at least water is contained as a solvent component, and water may be contained as a main solvent component. The “ink jet ink” refers to an ink composition ejected from an ink jet head by an ink jet method and used for recording.

Examples of the water include pure water such as ion-exchanged water, ultrafiltration water, reverse osmosis water, and distilled water, water having reduced ionic impurities such as ultrapure water, and the like. In addition, when water sterilized by ultraviolet irradiation or addition of hydrogen peroxide or the like is used, the generation of bacteria or fungi can be suppressed when the white ink composition is stored for a long period of time.

A content of water is preferably 50% by mass or more, and more preferably 50% to 100% by mass in a liquid medium component. Further, the content is preferably 60% to 90% by mass, and more preferably 70% to 80% by mass. Here, the liquid medium is a solvent component such as water and an organic solvent.

In addition, the content of water is preferably 30% by mass or more, more preferably 40% by mass or more, and even more preferably 50% by mass or more with respect to the total mass of the white ink composition. The upper limit of the water content is not particularly limited, but is, for example, preferably 99% by mass or less, more preferably 90% by mass or less, 80% by mass or less, 70% by mass or less, and 60% by mass or less with respect to the total mass of the white ink composition.

### 1.1.4 Alkali

The white ink composition may contain an alkali.

Examples of the alkali include inorganic alkali, organic alkali, and the like.

Examples of the inorganic alkali include lithium hydroxide, sodium hydroxide, potassium hydroxide, potassium dihydrogen phosphate, disodium hydrogen phosphate, potassium carbonate, sodium carbonate, sodium hydrogen carbonate, ammonia, and the like.

Examples of the organic alkali include triethanol amine, diethanol amine, monoethanol amine, tripropanol amine, triisopropanol amine, diisopropanol amine, and tris (hydroxymethyl)aminomethane (THAM), and the like.

A content of the alkali is preferably 0.1% by mass or less, more preferably 0.07% by mass or less, further preferably 0.05% by mass or less, particularly preferably 0.03% by mass or less, with respect to the total amount of the white ink composition, and 0% by mass (not contained) is more particularly preferable. A lower limit of the content when containing an alkali may be 0.01% by mass or more, 0.02% by mass or more, and 0.03% by mass or more, with respect to the total amount of the white ink composition.

Since the alkali tends to promote the hydrolysis of the polyether-modified silicone-based surfactant, when the content of the alkali is in the above range, the hydrolysis of the polyether-modified silicone-based surfactant can be further suppressed, and there is a tendency that embedment after long-term storage of the ink can be more favorable.

In other words, when the ink set according to the present embodiment is used, a specific polyether-modified silicone-based surfactant is used, and thus, even when the content of the alkali is in the above range, there is a tendency that the embedment after long-term storage of the ink can be more favorable.

The content of the inorganic alkali is preferably less than 0.03% by mass, more preferably less than 0.02% by mass, and further more preferably less than 0.01% by mass, with respect the total amount of the white ink composition, and 0% by mass (not contained) is more particularly preferable. The lower limit of the content when containing the inorganic alkali may be 0.001% by mass or more, 0.005% by mass or more, or 0.01% by mass or more with respect to the total amount of the white ink composition.

Since the inorganic alkali tends to particularly promote the hydrolysis of the polyether-modified silicone-based surfactant, when the content of the inorganic alkali is in the above range, there is a tendency that the hydrolysis of the polyether-modified silicone-based surfactant can be further suppressed and the embedment after long-term storage of the ink can be made more favorable.

In other words, when the ink set according to the present embodiment is used, a specific polyether-modified silicone-based surfactant is used, and thus, even when the content of the inorganic alkali is in the above range, there is a tendency that the embedment after long-term storage of the ink can be made more favorable.

### 1.1.5. Organic Solvent

The white ink composition may contain an organic solvent. When the ink composition contains an organic solvent, there is a tendency that the wet spreadability of the ink can be made more favorable, the embedment of the white ink on the recording medium can be made more favorable, and as a result, the occurrence of unevenness of color image can be reduced.

Examples of the organic solvent include esters, alkylene glycol ethers, cyclic esters, amides, alcohols, polyhydric alcohols, and the like.

Esters include glycol monoacetates such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate; and glycol diesters such as ethylene glycol diacetate, diethylene glycol diacetate, propylene glycol diacetate, dipropylene glycol diacetate, propionate ethylene glycol acetate, butyrate ethylene glycol acetate, butyrate diethylene glycol acetate, propionate diethylene glycol acetate, butyrate diethylene glycol acetate, propionate propylene glycol acetate, butyrate propylene glycol acetate, butyrate dipropylene glycol acetate, and propionate dipropylene glycol acetate.

The alkylene glycol ethers may be alkylene glycol monoethers or diethers, and are preferably alkyl ethers. Specific examples include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether; alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether; and the like.

Examples of cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone; compounds in which a hydrogen of a methylene group adjacent to a carbonyl group thereof is substituted with an alkyl group having 1 to 4 carbon atoms, and the like.

Examples of the amides include cyclic amides, acyclic amides, and the like. Examples of the acyclic amides include alkoxyalkylamides and the like.

Examples of the cyclic amides include lactams. Examples of lactams include pyrrolidones such as 2-pyrrolidone, 1-methyl-2-pyrrolidone, 1-ethyl-2-pyrrolidone, 1-propyl-2-pyrrolidone, 1-butyl-2-pyrrolidone, and 1-(2-hydroxyethyl) pyrrolidin-2-one.

Examples of alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, 3-tert-butoxy-N,N-methylethylpropionamide, N,N-dimethylisobutyrate amide, and the like.

Examples of alcohols include a compound in which one hydrogen atom of alkane is substituted with a hydroxyl group. The alkane preferably has 10 or less carbon atoms, more preferably 6 or less carbon atoms, and further more preferably 3 or less carbon atoms. The number of carbon atoms of the alkane is 1 or more, and is preferably 2 or more. The alkane may be a linear type or a branched type. Examples of alcohols include methanol, ethanol, n-propyl alcohol, iso-propyl alcohol, n-butanol, 2-butanol, tert-butanol, iso-butanol, n-pentanol, 2-pentanol, 3-pentanol, tert-pentanol, 2-phenoxy ethanol, benzyl alcohol, phenoxy propanol, and the like.

Polyhydric alcohols have two or more hydroxyl groups in the molecule. Examples of polyhydric alcohols include alkanediols and polyols.

Examples of alkanediols include compounds in which alkane is substituted with two hydroxyl groups. Examples of alkanediols include 1,2-alkanediol, which is a general term for compounds in which hydroxyl groups are substituted at the first and second positions of alkanes, and other alkanediols other than 1,2-alkanediol.

Examples of the 1,2-alkanediol include ethylene glycol, 1,2-propanediol (propylene glycol), 1,2-butanediol (1,2BD), 1,2-pentanediol (1,2PD), 1,2-hexanediol (1,2HD), 1,2-heptanediol, 1,2-octanediol, 1,2-nonanediol, 1,2-decanediol, 3-methyl-1,2-butanediol, 3-methyl-1,2-pentanediol, 4-methyl-1,2-pentanediol, 3, 4-dimethyl-1,2-pentanediol, 3-ethyl-1,2-pentanediol, 4-ethyl-1,2-pentanediol, 3-methyl-1,2-hexanediol, 4-methyl-1,2-hexanediol, 5-methyl-1,2-hexanediol, 3, 4-dimethyl-1,2-hexanediol, 3, 5-dimethyl-1,2-hexanediol, 4, 5-dimethyl-1,2-hexanediol, 3-ethyl-1,2-hexanediol, 4-ethyl-1,2-hexanediol, and 3-ethyl-4-methyl-1,2-hexanediol.

Examples of other alkanediols include 1,3-propanediol, 1,3-butylene glycol (also known as 1,3-butanediol), 1,4-butanediol, 2, 3-butanediol, 1,5-pentanediol, 2, 4-pentanediol, 2-methyl-1,3-propanediol, 3-methyl-1,3-butanediol, 3-methyl-1,5-pentanediol, 2-ethyl-1, 3-hexanediol, 2-methyl-1,3-pentanediol, 3-methyl-1, 5-pentanediol, 2-methylpentane-2, 4-diol, 1,6-hexanediol, 2-ethyl-2-methyl-1,3-propanediol, 2-methyl-2-propyl-1, 3-propanediol, and the like.

Among the alkanediols, alkanediols having 5 or more carbon atoms are preferable, and alkanediols having 5 to 10 carbon atoms are more preferable. Alternatively, alkanediol having 4 or less carbon atoms is preferable, and alkanediol having 2 to 3 carbon atoms is more preferable.

Examples of the polyols include a condensate in which two or more molecules of alkanediols are intermolecularly condensed between hydroxyl groups, a compound having three or more hydroxyl groups, and the like.

Examples of the condensate in which two or more molecules of alkanediols are intermolecularly condensed between hydroxyl groups include dialkylene glycol such as diethylene glycol and dipropylene glycol, trialkylene glycol such as triethylene glycol and tripropylene glycol, and the like.

A condensate in which two or more molecules of alkanediols having 4 or less carbon atoms are intermolecularly condensed with hydroxyl groups is preferable, and a condensate in which two or more molecules of alkanediols having 2 or 3 carbon atoms are intermolecularly condensed with hydroxyl groups is more preferable.

The compound having three or more hydroxyl groups is a compound having three or more hydroxyl groups having an alkane or polyether structure as a skeleton. Examples of the compound having three or more hydroxyl groups include glycerin, trimethylolethane, trimethylolpropane, 1, 2, 5-hexanetriol, 1, 2, 6-hexanetriol, pentaerythritol, polyoxypropylenetriol, and the like.

The organic solvent may be used alone or in combination of two or more thereof.

The content of the organic solvent is preferably 5% to 50% by mass, more preferably 5% to 40% by mass, and further more preferably 10% to 30% by mass, with respect to the total amount of the white ink composition. It is also preferable that the content of alkanediols is in the above range.

In the white ink composition, a content of the organic solvent having a standard boiling point of higher than 280° C. is preferably 5% by mass or less, more preferably 3% by mass or less, further more preferably 18 by mass or less, particularly preferably 0.5% by mass or less, and particularly preferably 0% by mass (not contained), with respect to the total amount of the white ink composition. Examples of the organic solvent having a standard boiling point of higher than 280° C. include triethylene glycol, glycerin, and the like.

### 1.1.6. Resin Particles

The white ink composition may contain resin particles. The resin particles function as a so-called fixing resin that improves the adhesion property and scratch resistance of components of the ink adhered to the recording medium. The properties of the resin particles may be in the form of a powder, but an emulsion form is preferable.

Examples of the resin of resin particles include urethane-based resin, acrylic resin, fluorene-based resin, polyolefin-based resin, rosin-modified resin, terpene-based resin, polyester-based resin, polyamide-based resin, epoxy-based resin, vinyl chloride-based resin, ethylene vinyl acetate-based resin, vinyl acetate resin, butadiene resin, styrene resin, crosslinked acrylic resin, crosslinked styrene resin, benzoguanamine resin, phenol resin, silicone resin, epoxy resin, paraffin resin, fluororesin, and the like.

A urethane-based resin is a general term for a resin having a urethane bond. For the urethane-based resin, a polyether-type urethane resin including an ether bond in the main chain, a polyester-type urethane resin including an ester bond in the main chain, and a polycarbonate-type urethane resin including a carbonate bond in the main chain, in addition to a urethane bond, and the like may be used. The urethane-based resin may be a commercially available product. For example, the urethane-based resin may be selected from commercially available urethane-based resins such as SUPERFLEX 210, 460, 460s, 840, and E-4000 (product name, manufactured by DKS Co., Ltd.), RESAMINE D-1060, D-2020, D-4080, D-4200, D-6300, and D-6455 (product name, manufactured by Dainichiseika Color & Chemicals Mfg.), TAKELAC WS-6020, WS-6021, and W-512-A-6 (product name, manufactured by Mitsui Chemicals Polyurethanes), SANCURE 2710 (product name, manufactured by LUBRIZOL), and PERMARIN UA-150 (product name, manufactured by Sanyo Chemical Industries).

An acrylic resin is a general term for polymers obtained by polymerizing at least an acrylic monomer such as (meth)acrylic acid and (meth)acrylic acid ester as one component, and examples thereof include a resin obtained from an acrylic monomer, a copolymer of an acrylic monomer and a monomer other than acrylic monomer, and the like. Examples thereof include an acrylic-vinyl-based resin which is a copolymer of an acrylic monomer and a vinyl-based monomer and the like. In addition, examples thereof include a copolymer with a vinyl-based monomer such as styrene. For example, a styrene acrylic resin can be exemplified.

As the acrylic monomer, acrylamide, acrylonitrile, and the like can also be used.

The acrylic resin may be a commercially available product, and may be selected from, for example, FK-854 (product name, manufactured by Chuo Kagaku Kogyo Co., Ltd.), MOVINYL 6969D, 952B, 718A (product name, manufactured by Nippon Synthetic Chemical Industry Co., Ltd.), NIPOL LX852, LX874 (product name, manufactured by Nippon Zeon Corporation), POLYSOL AT860 (manufactured by Showa Denko K.K.), VONCOAT AN-1190S, YG-651, AC-501, AN-1170, 4001 (product name, manufactured by DIC Corporation, acrylic resin emulsion), and the like.

In addition, in the present specification, the acrylic resin may be a styrene acrylic resin as mentioned above.

The styrene acrylic resin is a copolymer obtained from a styrene monomer and an acrylic monomer, and examples thereof include a styrene-acrylic acid copolymer, a styrene-methacrylic acid copolymer, a styrene-methacrylic acid-acrylic acid ester copolymer, a styrene-a-methylstyrene-acrylic acid copolymer, a styrene-a-methylstyrene-acrylic acid-acrylic acid ester copolymer, and the like. The styrene acrylic resin may be a commercially available product, and examples thereof include JONCRYL 62J, 7100, 390, 711, 511, 7001, 631, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, 7610 (product name, manufactured by BASF), MOVINYL 966A, 975N (product name, manufactured by Nippon Synthetic Chemical Industry Co., Ltd.), and the like.

The vinyl chloride-based resin may be a vinyl chloride-vinyl acetate copolymer.

The polyolefin-based resin has an olefin such as ethylene, propylene, and butylene in the structural skeleton, and known ones can be appropriately selected and used. As the polyolefin-based resin, a commercially available product can be used, and for example, may be selected and used from ARROWBASE CB-1200, CD-1200 (product name, manufactured by Unitika Ltd.), HITEC E-6500 (product name, manufactured by Toho Chemical Industry Co., Ltd., polyethylene wax emulsion), SN-2002 (product name, manufactured by Toho Chemical Industry Co., Ltd., polyester resin emulsion), and the like.

In addition, examples of commercially available product of resin emulsion may be selected and used from MICROGEL E-1002 and E-5002 (product name manufactured by Nippon Paint Corporation, styrene-acrylic resin emulsion), VONCOAT AN-1190S, YG-651, AC-501, AN-1170, 4001, and 5454 (product name manufactured by DIC Corporation, styrene-acrylic resin emulsion), POLYSOL AM-710, AM-920, AM-2300, AP-4735, AT-860, and PSASE-4210E (acrylic resin emulsion), POLYSOL AP-7020 (styrene-acrylic resin emulsion), POLYSOL SH-502 (vinyl acetate resin emulsion), POLYSOL AD-13, AD-2, AD-10, AD-96, AD-17, and AD-70 (ethylene-vinyl acetate resin emulsion), POLYSOL PSASE-6010 (ethylene-vinyl acetate resin emulsion) (product name manufactured by Showa Denko product), POLYSOL SAE1014 (product name, styrene-acrylic resin emulsion, Nippon Zeon Corporation), SAIVINOL SK-200 (product name, an acrylic resin emulsion, Saiden Chemical Industry), AE-120A (product name manufactured by JSR, acrylic resin emulsion), AE373D (product name manufactured by Emulsion Technology, carboxy-modified styrene-acrylic resin emulsion), SEIKADYNE 1900 W (product name manufactured by Dainichiseika Color & Chemicals Mfg., ethylene-vinyl acetate resin emulsion), VINYBLAN 2682 (acrylic resin emulsion), VINYBLAN 2886 (vinyl acetate-acrylic resin emulsion), VINYBLAN 5202 (acetic acid-acrylic resin emulsion), (product name manufactured by Nissin Chemical Industry), VINYBLAN 700, 2586 (manufactured by Nissin Chemical Industry, ELITEL KA-5071S, KT-8803, KT-9204, KT-8701, KT-8904, and KT-0507 (product name manufactured by Unitika, polyester resin emulsion), HITEC E-6500 (product name manufactured by Toho Chemical Industry Co., Ltd., polyethylene wax emulsion), SN-2002 (product name manufactured by Toho Chemical Industry Co., Ltd., polyester resin emulsion), TAKELAC W-6020, W-635, W-6061, W-605, W-635, and W-6021 (product name manufactured by Mitsui Chemicals Polyurethanes, urethane-based resin emulsion), SUPERFLEX 870, 800, 150, 420, 460, 470, 610, 620, and 700 (product name manufactured by DKS Co., Ltd., urethane-based resin emulsion), PERMARIN UA-150 (manufactured by Sanyo Chemical Industries, urethane-based resin emulsion), SANCURE 2710 (manufactured by Lubrizol Japan, urethane-based resin emulsion), NeoRez R-9660, R-9637, and R-940 (manufactured by Kusumoto Chemicals Ltd., urethane-based resin emulsion), ADEKA BONTIGHTER HUX-380 and 290K (manufactured by ADEKA Corporation, urethane-based resin emulsion), MOVINYL 966A and MOVINYL 7320 (manufactured by Japan Coating Resin), JONCRYL 7100, 390, 711, 511, 7001, 631, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (all manufactured by BASF), NK Binder R-5HN (manufactured by Shin-Nakamura Chemical Co., Ltd.), HYDRAN WLS-210 (non-crosslinked polyurethane, manufactured by DIC Corporation), and the like.

In addition, a glass transition temperature (Tg) of the resin particles is preferably 50° C. or higher, more preferably 60° C. or higher, and further more preferably 70° C. or higher. On the other hand, the temperature is preferably 120° C. or lower, more preferably 100° C. or lower, further more preferably 90° C. or lower, and particularly preferably 80° C. or lower. When the glass transition temperature (Tg) of the resin particles is within the above range, the clogging recovery property may be excellent. The glass transition temperature (Tg) of the resin particles can be confirmed by a method using differential scanning calorimetry (DSC) or the like.

A content of the resin particles (solid content) is preferably 3% by mass or more, more preferably 5% by mass or more, further more preferably 8% by mass or more, and particularly preferably 10% by mass or more, with respect to the total amount of the white ink composition. In addition, the content of the resin particles (solid content) is preferably 30% by mass or less, more preferably 20% by mass or less, and further more preferably 15% by mass or less, with respect to the total amount of the white ink composition.

### 1.1.7. Wax

The white ink composition may contain a wax. Examples of the wax include, although not particularly limited, a hydrocarbon wax and an ester wax which is a condensate of fatty acid and monohydric alcohol or polyhydric alcohol. Although not particularly limited, examples of the hydrocarbon wax include a paraffin wax and polyolefin waxes such as polyethylene wax and polypropylene wax. These waxes may be used alone or in combination of two or more thereof.

Examples of commercially available paraffin wax include, AQUACER497 and AQUACER539 (product names, manufactured by BYK).

Examples of commercially available polyolefin wax include, Chemipearl S120, S650, and S75N (product names, manufactured by Mitsui Chemicals, Inc.), AQUACER501, AQUACER506, AQUACER513, AQUACER515, AQUACER526, AQUACER593, and AQUACER582 (product names, manufactured by BYK).

A content of the wax (solid content) is preferably 0.1% by mass or more, more preferably 0.5% by mass or more, further more preferably 1.0% by mass or more, and particularly preferably 1.5% by mass or more, with respect to the total amount of the white ink composition. In addition, the content of the wax (solid content) is preferably 10% by mass or less, more preferably 5% by mass or less, and further more preferably 3% by mass or less, with respect to the total amount of the white ink composition.

### 1.1.8 Metal Sealing Agent

The white ink composition may contain a metal sealing agent (chelating agent). The metal sealing agent can remove predetermined ions in a reaction solution.

Examples of the metal sealing agent include ethylenediamine tetraacetic acid such as ethylenediamine tetraacetic acid (EDTA), ethylenediamine tetraacetic acid dihydrogen disodium salt (EDTA-2Na), ethylenediamine tetraacetic acid monohydrogen trisodium salt (EDTA-3Na), ethylenediamine tetraacetic acid tetrasodium salt (EDTA-4Na), and ethylenediamine tetraacetic acid monohydrogen tripotassium salt (EDTA-3K) and salts thereof; diethylenetriamine pentaacetic acid such as DTPA, diethylenetriamine pentaacetic acid disodium salt (DTPA-2Na), and diethylenetriamine pentaacetic acid pentasodium salt (DTPA-5Na) and salts thereof; nitrilotriacetic acid such as NTA, nitrilotriacetic acid disodium salt (NTA-2Na), and nitrilotriacetic acid trisodium salt (NTA-3Na) and salts thereof; ethylenediamine-N, N′-disuccinic acid and salts thereof; 3-hydroxy-2,2′-iminodisuccinic acid and salts thereof; L-aspartic acid-N,N′-diacetic acid and salts thereof; and N-(2-hydroxyethyl)imminodiacetic acid and salts thereof. In addition, examples of the metal sealing agent include ethylenediaminetetramethylenephosphonic acid and salts thereof; ethylenediaminetetramethaphosphoric acid and salts thereof; ethylenediaminepyrophosphoric acid and salts thereof; and ethylenediaminemethaphosphoric acid and salts thereof.

The metal sealing agent may be used alone, or may be used in combination of two or more.

When the metal sealing agent is contained, a content thereof can be, for example, 0.005% by mass or more and 0.1% by mass or less, and preferably 0.01% by mass or more and 0.05% by mass or less, with respect to the total amount of the white ink composition.

### 1.1.9 Other Components

The white ink composition may contain additives such as a pH adjusting agent other than an alkali, a preservative/antifungal agent, an antirust agent, a viscosity modifier, a solubilizing agent, and an antioxidant, as necessary. When such an additive is contained, a content of the additive is preferably 0.1% to 5% by mass, more preferably 0.18 to 38 by mass, and further more preferably 0.1% to 18 by mass, with respect to the total amount of the white ink composition.

### 1.1.10 Physical Properties

### 1.1.10.1 Contact Angle

It is preferable that a contact angle change rate of the white ink composition with respect to polyethylene terephthalate, which is obtained by Formula (3), is less than 10%.

$$Contact angle change rate ( \% ) = \vert 5 , 000 ms contact angle of the ink composition after being left to stand at 25 ° C . for 12 months - 5 , 000 ms contact angle of the ink composition before being left to stand \vert \text{} / 5 , 000 ms contact angle of the ink composition before being left to stand \times 100 \qquad Formula ( 3 )$$

A surface tension of the white ink tended not to change before and after long-term storage. This is because, even when the silicone-based surfactant is hydrolyzed and the content of the silicone-based surfactant decreases, and even when the hydrolyzate is generated, the decrease in the surface tension of the ink is also contributed by other components such as the organic solvent. Therefore, it is presumed that the surface tension is less likely to change before and after long-term storage.

On the other hand, as a result of detailed examination, it was found that the contact angle with respect to a predetermined base material changes before and after long-term storage. It was found that, with the above specific polyether-modified silicone-based surfactant, the change in the contact angle with respect to the predetermined base material can be reduced before and after long-term storage, to make the embedment of the white ink on the recording medium favorable, and as a result, the occurrence of unevenness of a color image can be reduced.

The acetylene glycol-based surfactant is less likely to undergo hydrolysis, and the contact angle does not change before and after long-term storage. However, the wet spreadability of the ink on the low-absorptive recording medium or the non-absorptive recording medium is inferior.

The contact angle change rate of the white ink composition with respect to polyethylene terephthalate, which is obtained by Formula (3), is preferably less than 8%, more preferably less than 5%, and particularly preferably less than 3%.

In the condition in the above-described Formula (3), the contact angle change rate (%) when “being left to stand at 25° C. for 12 months” is changed to “being left to stand at 40° C. for 2 months” is also preferably within the above-described range.

### 1.1.10.2 Viscosity

A viscosity of the white ink composition is preferably 1.0 to 10 mPa·s, more preferably 2.0 to 10 mPa·s, further more preferably 3.0 to 8.0 mPa·s, and particularly preferably 4.0 to 6.0 mPa·s at 20° C. In particular, when the viscosity is 4.0 mPa's or more, there is a tendency that more favorable color development properties are obtained.

When the viscosity is 6.0 mPa's or less, there is a tendency that more favorable ejection stability is obtained.

### 1.1.10.3 Surface Tension

A surface tension of the white ink composition is preferably 10 to 40 mN/m, more preferably 15 to 35 mN/m, further more preferably 20 to 30 mN/m, and particularly preferably 20 to 27 mN/m at 20° C.

### 1.2 Non-White Ink Composition

The ink set according to the present embodiment has a non-white ink composition containing a non-white color material, and the non-white ink composition is an aqueous ink jet ink.

The non-white ink composition may have the same composition as the composition that the white ink composition may have, except that the non-white ink composition contains a non-white color material instead of the white color material and does not contain the specific polyether-modified silicone-based surfactant described above.

The non-white ink composition is an ink having a color other than white, and the color is not limited but may be, for example, black ink, yellow ink, magenta ink, cyan ink, orange ink, green ink, or the like.

Hereinafter, each component contained in the non-white ink composition will be described. Hereinafter, the components common to the above-mentioned white ink composition can have the same composition as the white ink composition, unless otherwise specified.

### 1.2.1 Non-White Color Material

The non-white ink composition contains a non-white color material. The non-white color material is a color material other than the white color material, and examples thereof include non-white pigments and dyes. As the pigment, for example, an inorganic pigment or an organic pigment can be used.

The inorganic pigment is not particularly limited, and examples thereof include carbon blacks such as C.I. Pigment Black 6 (lamp black, vegetable black), C.I. Pigment Black 7 (furnace black, channel black, thermal black, acetylene black), C.I. Pigment Black 8 (charcoal black), and C.I. Pigment Black 10 (graphite).

Examples of commercially available product of carbon black include No. 2300, 900, MCF88, No. 20B, No. 33, No. 40, No. 45, No. 52, MA7, MA8, MA100, No. 2200B, and the like manufactured by Mitsubishi Chemical Corporation; Color Black FW1, FW2, FW2V, FW18, FW200, S150, S160, S170, Pretex 35, U, V, 140U, Special Black 6, 5, 4A, 4, 250, and the like manufactured by Degussa Corporation; Conductex SC, Raven 1255, 5750, 5250, 5000, 3500, 1255, 700, and the like manufactured by Columbia Carbon Company; Regal 400R, 330R, 660R, Mogul L, Monarch 700, 800, 880, 900, 1000, 1100, 1300, 1400, Elftex 12, and the like manufactured by Cabot Corporation; and the like.

Examples of the organic pigment include a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzoimidazolone-based pigment, an isoindolinone-based pigment, an azomethine-based pigment, an azo-based pigment, and the like.

Specific examples of the organic pigment include the following ones.

Examples of the cyan pigment include C.I. Pigment Blue 1, 2, 3, 15:3, 15:4, 15:34, 16, 22, 60, and the like; C.I. Vat Blue 4, 60; and the like, and are preferably a mixture of one or two or more selected from the group consisting of C.I. Pigment Blue 15:3, 15:4, and 60.

Examples of the magenta pigment include C.I. Pigment Red 5, 7, 12, 48 (Ca), 48 (Mn), 57 (Ca), 57:1, 112, 122, 123, 168, 184, 202, C.I. Pigment Violet 19, and the like, and are preferably a mixture of one or two or more selected from the group consisting of C.I. Pigment Red 122, 202, and 209, and C.I. Pigment Violet 19.

Examples of the yellow pigment include C. I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, 185, and the like, and preferably include a mixture of one or two or more selected from the group consisting of C. I. Pigment Yellow 74, 109, 110, 128, 138, 150, and 180.

Pigments of other colors can also be used. Examples thereof include an orange pigment, a green pigment, and the like.

The pigment may be used alone, or may be used in combination of two or more.

Even in the pigment as a non-white color material, it is the same as the white color material that it is preferable to perform a surface treatment on the color material or to blend a dispersant or the like in order to enhance the dispersibility in the ink composition, and the same description as mentioned above can be made.

Although not particularly limited, acid dye, direct dye, reactive dye, and basic dye can be used as the dye. The dye may be used alone or in combination of two or more.

The dye is not particularly limited, but examples thereof include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

A content of the non-white color material is preferably 0.1% by mass or more and 10% by mass or less, more preferably 18 by mass or more and 8% by mass or less, and further more preferably 2% by mass or more and 6% by mass or less, with respect to the total amount of the non-white ink composition.

### 1.2.2 Water

The non-white ink composition is an aqueous ink jet ink. The “aqueous” composition can be the same as that of the above-mentioned white ink composition.

A content of water is preferably 50% by mass or more, and more preferably 50% to 100% by mass in a liquid medium component. Further, the content is preferably 60% to 90% by mass, and more preferably 75% to 85% by mass. Here, the liquid medium is a solvent component such as water and an organic solvent.

In addition, the content of water is preferably 30% by mass or more, more preferably 40% by mass or more, and further more preferably 50% by mass or more, with respect to the total mass of the non-white ink composition. An upper limit of the water content is not particularly limited, but is, for example, preferably 99% by mass or less, more preferably 90% by mass or less, and 80% by mass or less, with respect to the total mass of the non-white ink composition.

### 1.2.3 Polyether-Modified Silicone-Based Surfactant

The non-white ink composition may contain a polyether-modified silicone-based surfactant. In this case, it is preferable that the surface tension of the non-white ink composition is easily adjusted to a suitable range for the ink jet ink.

The polyether-modified silicone-based surfactant is not limited to the above-mentioned polyether-modified silicone-based surfactant having a weight average molecular weight Mw of 2,000 or less (specific polyether-modified silicone-based surfactant). That is, the non-white ink composition may contain a specific polyether-modified silicone-based surfactant, or may contain a polyether-modified silicone-based surfactant other than the specific polyether-modified silicone-based surfactant (hereinafter, also referred to as “other polyether-modified silicone-based surfactant”).

Since the specific polyether-modified silicone-based surfactant is as mentioned above, the description thereof will be omitted.

The weight average molecular weight Mw of the other polyether-modified silicone-based surfactant is not particularly limited, but is preferably 8,000 or less, more preferably 7,000 or less, and further more preferably 5,000 or less. In addition, a lower limit of the weight average molecular weight Mw is not particularly limited, but is preferably more than 2,000, more preferably more than 3,000, and further more preferably more than 4,000.

It is also preferable to measure the weight average molecular weight Mw of the other polyether-modified silicone-based surfactant by gel permeation chromatography (GPC) as mentioned above.

The surface tension of a 0.1% by mass aqueous solution of the other polyether-modified silicone-based surfactant is preferably 35 mN/m or less, more preferably 33 mN/m or less, further more preferably 30 mN/m or less, and particularly preferably 28 mN/m or less. The lower limit of the surface tension is not particularly limited, but is preferably 15 mN/m or more, more preferably 17 mN/m or more, and even more preferably 20 mN/m or more.

Examples of other polyether-modified silicone-based surfactants include BYK-333 (product name manufactured by Big Chemie Japan Co., Ltd., weight average molecular weight Mw of 4,000 to 7,000), BYK-3480 (product name manufactured by Big Chemie Japan Co., Ltd., weight average molecular weight Mw of 4,000 to 4,500), PD508 (product name manufactured by Nisshin Chemical Industry Co., Ltd., weight average molecular weight Mw of 6,230), and the like.

A content of the polyether-modified silicone-based surfactant in the non-white ink composition can be the same as the content of the specific polyether-modified silicone-based surfactant in the white ink composition.

### 1.2.4 Organic Solvent

The non-white ink composition may contain an organic solvent. When the ink composition contains the organic solvent, there is a tendency that the wet spreadability of the ink can be made more favorable, and there is a tendency that the occurrence of unevenness of a color image can be further reduced.

The composition of the organic solvent in the non-white ink composition can be the same as that of the above-mentioned white ink composition.

### 1.2.5 Alkali

The non-white ink composition may contain an alkali. The composition of the alkali in the non-white ink composition can be the same as that of the above-mentioned white ink composition.

A content of the alkali is preferably 0.01% by mass to 3% by mass, more preferably 0.05% by mass to 1% by mass, and further more preferably 0.1% by mass to 0.5% by mass, with respect to the total amount of the non-white ink composition.

### 1.2.6 Resin Particles

The non-white ink composition may contain resin particles. The composition of the resin particles in the non-white ink composition can be the same as that of the above-mentioned white ink composition.

A content of the resin particles (solid content) is preferably 0.1% by mass or more, more preferably 0.5% by mass or more, further more preferably 1% by mass or more, and particularly preferably 2% by mass or more, with respect to the total amount of the non-white ink composition. In addition, the content of the resin particles (solid content) is preferably 15% by mass or less, more preferably 10% by mass or less, and further more preferably 8% by mass or less, with respect to the total amount of the non-white ink composition.

### 1.2.7 Wax

The non-white ink composition may contain a wax. The composition of the wax in the non-white ink composition can be the same as that of the above-mentioned white ink composition.

### 1.2.8 Metal Sealing Agent

The non-white ink composition may contain a metal sealing agent. The composition of the metal sealing agent in the non-white ink composition can be the same as that of the above-mentioned white ink composition.

### 1.2.9 Other Components

The non-white ink composition may contain additives such as a pH adjusting agent other than an alkali, a preservative/antifungal agent, an antirust agent, a viscosity modifier, a solubilizing agent, and an antioxidant, as necessary. When such an additive is contained, a content of the additive is preferably 0.1% to 5% by mass, more preferably 0.1% to 3% by mass, and further more preferably 0.1% to 18 by mass with respect to the total amount of the non-white ink composition.

### 1.2.10 Physical Properties

The viscosity and surface tension in the non-white ink composition can be the same as that of the above-mentioned white ink composition.

### 1.3 Use

The ink set according to the present embodiment is used for recording on a low-absorptive recording medium or a non-absorptive recording medium.

The term low-absorptive recording medium or non-absorptive recording medium refers to a recording medium having a property of not absorbing liquid at all or absorbing little liquid. Quantitatively, the low-absorptive recording medium or non-absorptive recording medium refers to “a recording medium in which a water absorption amount from the start of contact to 30 msec^{1/2} in the Bristow method is 10 mL/m² or less”. The Bristow method is the most popular method as a method of measuring a liquid absorption amount in a short time, and is also adopted by the Japan Technical Association of the Pulp and Paper Industry (JAPAN TAPPI). Details of a test method are described in “Paper and Paperboard-Liquid-Absorptivity Test Method-Bristow Method” of Standard No. 51 of “JAPAN TAPPI Paper and Pulp Test Method 2000 Edition”. On the other hand, the absorptive recording medium refers to a recording medium that does not correspond to a low-absorptive recording medium or a non-absorptive recording medium.

Examples of the low-absorptive recording medium include a recording medium having a low-absorptive coating layer provided on a surface thereof, and the low-absorptive recording medium is referred to as a coated paper. Examples of the recording medium whose base material is paper include printed paper such as art paper, coated paper, and matte paper. When the base material is a plastic film, examples thereof include recording media in which a polymer or the like is coated onto a surface such as polyvinyl chloride, polyethylene terephthalate, polycarbonate, polystyrene, polyurethane, polyethylene, and polypropylene, and recording media in which particles such as silica, titanium, and the like are coated with a binder.

Examples of the non-absorptive recording medium include a medium in which plastic is coated on a base material such as paper, a medium in which a plastic film adheres to the base material such as paper, and a plastic film without an absorbing layer (receiving layer). Examples of the plastic include polyvinyl chloride, polyethylene terephthalate, polycarbonate, polystyrene, polyurethane, polyethylene, polypropylene, and the like.

### 2. Recording Method

A recording method according to an embodiment of the present disclosure is the recording method performed using the above-mentioned ink set, and includes a white ink adhesion step of adhering the above-mentioned white ink composition to a recording medium by an ink jet method, and a non-white ink adhesion step of adhering the above-mentioned non-white ink composition to the recording medium by an ink jet method, in which the recording medium is a low-absorptive recording medium or a non-absorptive recording medium.

According to the recording method according to the present embodiment, by using the above-mentioned ink set, the embedment of the white ink on the recording medium can be made favorable, and as a result, the occurrence of unevenness of the color image can be reduced.

Hereinafter, each step of the recording method according to the present embodiment will be described.

The recording medium, which is a low-absorptive recording medium or a non-absorptive recording medium, is as mentioned above, and thus the description thereof will be omitted.

### 2.1 White Ink Adhesion Step

The recording method according to the present embodiment includes a white ink adhesion step of adhering the above-mentioned white ink composition to a recording medium by an ink jet method.

The “ink jet method” is a method in which droplets of an ink jet ink are ejected from a nozzle of an ink jet head and adhered to a recording medium.

An adhesion amount of the white ink composition is preferably 4 to 30 mg/inch², more preferably 6 to 25 mg/inch², further more preferably 8 to 20 mg/inch², and particularly preferably 10 to 15 mg/inch² per unit area of a region where the white ink composition is adhered on the recording medium. In addition, among the adhesion amount of the white ink composition, a maximum adhesion amount may be in the above range, which is preferable.

An order of the white ink adhesion step and the non-white ink adhesion step described later is not particularly limited, but it is preferable that the non-white ink adhesion step is performed after the white ink adhesion step, and the white ink composition and the non-white ink composition are overlapped and adhered on the recording medium. That is, it is a preferable aspect that a white image formed by the white ink composition is made on the recording medium first, and then a color image formed by the non-white ink composition is formed by being overlaid on the white image on the recording medium.

In this case, unevenness of the color image is likely to occur, and thus the recording method according to the present embodiment is more effective.

A preferable adhesion aspect is that the white ink adhesion step and the non-white ink adhesion step described later are performed by scanning (hereinafter, also referred to as “the scanning”) in which the ink is ejected from the ink jet head and adhered to the recording medium when the ink jet head and the recording medium are being moved to a relative position.

In the scanning, the ink jet head may move with respect to the recording medium, or the recording medium may move with respect to the ink jet head. That is, the movement of the ink jet head to a relative position with respect to the recording medium can be referred to as a movement of the recording medium to a relative position with respect to the ink jet head. That is, the relative position of the ink jet head and the recording medium is moved.

The ink jet head can be mounted on, for example, a carriage. The ink jet head may move by moving the carriage, and, that is, even this case is a movement of the ink jet head.

The number of times of the scanning performed on the same scanning region on the recording medium is not particularly limited, and may be one or a plurality of times independently in each of the white ink adhesion step and the non-white ink adhesion step.

When the number of times of the scanning performed on the same scanning region on the recording medium is set to a plurality of times, the ink jet head that ejects the ink passes through the same region on the recording medium a plurality of times. As the number of times of scanning increases, the ink can be adhered on a desired region a plurality of times (in a plurality of times of pass), and there is a tendency that the image quality of the obtained recorded matter is further improved. In this case, the number of times of scanning is preferably 2 or more, more preferably 3 or more, further more preferably 4 or more, and particularly preferably 6 or more from a viewpoint of the image quality being more excellent. An upper limit is not limited, but, from a viewpoint of productivity, is preferably 24 or less, more preferably 12 or less, and further more preferably 8 or less. The number of times of the above-described scanning is provided for each type of ink.

In such a case of the plurality of passes, it is preferable to perform recording by performing the scanning (main scanning) and the sub-scanning a plurality of times, respectively. For example, the main scanning and the sub-scanning may be alternately repeated.

For example, when recording is performed in four passes, when the length of one sub-scan in the sub-scanning direction is one fourth of the length of the nozzle row in the sub-scanning direction of the ink jet head, which is in the sub-scanning direction, four main scans are performed on the same portion (same scanning region) for a rectangular scanning region extending in the main scanning direction and having the length of one sub-scan in the sub-scanning direction. The number of times of scanning when viewed in this way is referred to as the number of scanning, the number of passes, or the like.

The “sub-scanning” refers to an operation of moving the relative position of the ink jet head and the recording medium in the sub-scanning direction. The “sub-scanning direction” is a direction intersecting the main scanning direction (that is, a direction in which the relative position of the ink jet head with respect to the recording medium is moved).

For example, the ink is adhered to a region of the recording medium in the main scanning, the recording medium is slightly moved in the sub-scanning, for example, and the next main scanning is further performed. By repeating the operation of adhering the ink adjacent to or partially overlapping the ink adhered first, recording can be performed. Also, the “sub-scanning” is a movement of the ink jet head to the relative position with respect to the recording medium. The ink jet head may move to the recording medium, and the recording medium may move to the ink jet head. A direction of such a relative movement is a sub-scanning direction.

On the other hand, it is preferable that the number of times of the scanning performed on the same scanning region in the recording medium be set to one time in the white ink adhesion step and one time in the non-white ink adhesion step. In this case, the white ink is likely to be insufficiently embedded on the recording medium, and unevenness of the color image is also likely to occur. However, according to the recording method according to the present embodiment, even in such an aspect, the embedment of the white ink on the recording medium can be made favorable and the occurrence of unevenness of the color image can be reduced.

When the number of times of the scanning performed on the same scanning region on the recording medium is set to one time in the white ink adhesion step and one time in the non-white ink adhesion step, the scanning may be performed by the same scanning or may be performed by different scanning.

### 2.2. Non-White Ink Adhesion Step

The recording method according to the present embodiment includes a non-white ink adhesion step of adhering the above-mentioned non-white ink composition to a recording medium by an ink jet method.

The adhesion amount of the non-white ink composition is preferably 2.0 to 20 mg/inch², more preferably 3.0 to 10 mg/inch², and further more preferably 6.0 to 8.0 mg/inch² per unit area of the region where the non-white ink composition is adhered on the recording medium. In addition, among the adhesion amount of the non-white ink composition, a maximum adhesion amount may be in the above range, which is preferable.

### 2.3 Primary Drying Step

The recording method according to the present embodiment may have a primary drying step in the white ink adhesion step. In this case, the drying property is further improved, and the abrasion resistance of the obtained recorded matter can be further improved. However, the embedment of the white ink on the recording medium is likely to be insufficient, and unevenness of the color image is likely to occur. However, according to the recording method according to the present embodiment, even in such an aspect, there is a tendency that the embedment of the white ink on the recording medium can be made favorable and the occurrence of the unevenness of the color image can be reduced.

A primary drying step is a step of heating the recording medium before the white ink adhesion step, or performing heating or blowing on the recording medium during the white ink adhesion step or in the early stage after the ink is adhered to the recording medium to dry the ink at an early stage.

The primary drying step is a step for drying at least a part of a solvent component in the ink to an extent that the ink adhered to the recording medium is at least reduced in the flow of the ink. The primary drying step may be performed so that the ink is adhered to the heated recording medium, or may be performed at an early stage after the adhesion to promote drying.

In the primary drying step, it is preferable that the ink droplet that has landed on the recording medium starts to dry within 0.5 seconds at the latest from the landing of the ink droplet. The drying unit (drying mechanism) for drying the ink on the recording medium is not particularly limited, but examples thereof include a platen heater, a hot air heater, an IR heater, and the like having a heating function, and a blower or the like having no heating function.

Examples of the type of the drying mechanism include a conductive type that conducts heat from a member in contact with the recording medium to the recording medium to heat the recording medium, a radiation type that radiates radiation such as IR to the recording medium to heat the recording medium, and a blowing type that blows air toward the recording medium.

Examples of the blowing type include a method of heating the recording medium when blowing air with warm air, and a method of promoting drying of the ink with air at room temperature without heating. In a method that does not include heating, it is preferable that the ink in the nozzles of the ink jet head can be suppressed from drying to decrease ejection stability. It is also preferable to use any one of the conductive type and the radiation type, and the blowing type in combination. When used in combination, a method that does not include heating may be used, which is preferable.

In the primary drying step, the surface temperature of the recording medium is preferably 60° C. or lower, and more preferably 55° C. or lower. Furthermore, the temperature is more preferably 30° C. to 50° C., and more preferably 40° C. to 45° C. On the other hand, the temperature is more preferably 40° C. or lower, further preferably 35° C. or lower, particularly preferably 30° C. or lower, and further more preferably 25° C. to 28° C.

When the surface temperature of the recording medium is within the above range, there is a tendency that the drying property is further improved, and the abrasion resistance of the obtained recorded matter is further improved. In addition, it is preferable that the clogging recovery property, the ejection stability, or the color development properties are more excellent.

The primary drying step may not be performed, or the step including heating as the primary drying step may not be performed. In this case, the surface temperature of the recording medium on the platen may be equal to or lower than the above range.

When the blowing type is used, the wind speed in the vicinity of the recording medium is preferably 0.5 to 10 m/s, more preferably 1 to 5 m/s, and further more preferably 2 to 3 m/s. The wind temperature is preferably 45° C. or lower, more preferably 40° C. or lower, further more preferably 32° C. or lower, and particularly preferably 20° C. to 27° C.

### 2.4 Secondary Drying Step

The recording method according to the present embodiment may include a step of heating and drying a recording medium to which an ink is adhered (secondary drying step). The secondary drying step is a step in which recording is completed and the recorded matter is sufficiently dried to the extent that the recorded matter can be used. In addition, the secondary drying step is a step of sufficiently drying the solvent component of the ink and heating the resin contained in the ink to form a flat ink coating film.

In the secondary drying step, it is preferable that the secondary drying step is started after more than 0.5 seconds have elapsed since the non-white ink composition is adhered to the recording medium. For example, it is preferable to start the heating and drying on a recording region after more than 0.5 seconds have elapsed since the adhesion of the non-white ink composition to the recording region of the recording medium was completed.

The surface temperature of the recording medium in the secondary drying step is preferably 50° C. or higher, more preferably 60° C. or higher, and further more preferably 70° C. or higher. In the secondary drying step, when the surface temperature of the recording medium is heated to 60° C. or higher, in particular, there is a tendency that the drying property is excellent, and the wet abrasion resistance can be made more favorable.

As the secondary drying mechanism, a conductive type, a radiation type, a blowing type, or the like can be used.

### 2.5 Recording Device

An example of a recording device suitable for the recording method according to the present embodiment will be described with reference to the drawings.

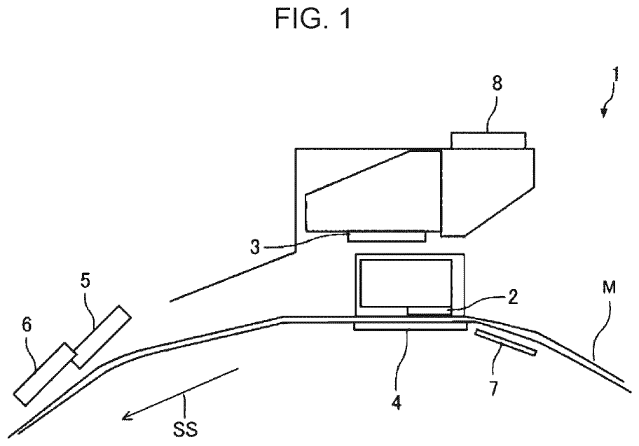

FIG. 1 is a schematic cross-sectional view schematically showing an ink jet recording device 1.

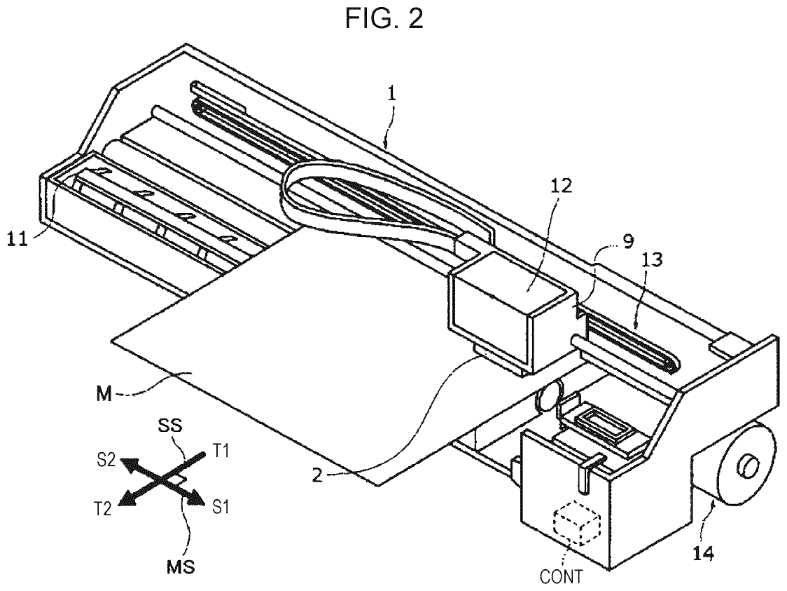

FIG. 2 is a perspective view showing an example of a configuration around a carriage of an ink jet recording device 1 of FIG. 1.

As shown in FIGS. 1 and 2, the ink jet recording device 1 includes an ink jet head 2, an IR heater 3, a platen heater 4, a heating heater 5, a cooling fan 6, a preheater 7, a ventilation fan 8, a carriage 9, a platen 11, a carriage moving mechanism 13, a transport unit 14, and a controller CONT. In the ink jet recording device 1, the operation of the entire ink jet recording device 1 is controlled by the controller CONT shown in FIG. 2.

The ink jet head 2 has an ink jet head that ejects a white ink composition and an ink jet head that ejects a non-white ink composition, and can perform recording on a recording medium M by ejecting the white ink composition and the non-white ink composition from nozzles of each of the ink jet heads and adhering the white ink composition and the non-white ink composition.

In the present embodiment, the ink jet head 2 is a serial type ink jet head, and scans the recording medium M one or a plurality of times in a main scanning direction relative to the recording medium M to adhere the white ink composition and the non-white ink composition to the recording medium M. The ink jet head 2 is mounted on the carriage 9 shown in FIG. 2. The ink jet head 2 is scanned one or a plurality of times in the main scanning direction relative to the recording medium M by an operation of the carriage moving mechanism 13 that moves the carriage 9 in a medium width direction of the recording medium M. The medium width direction is the main scanning direction of the ink jet head 2. Scanning in the main scanning direction is also referred to as main scanning.

In addition, here, the main scanning direction is a direction in which the carriage 9 on which the ink jet head 2 is mounted moves. In FIG. 1, the main scanning direction is a direction intersecting a sub-scanning direction, which is a transport direction of the recording medium M indicated by the arrow SS. In FIG. 2, a width direction of the recording medium M, that is, a direction represented by S1↔S2 is a main scanning direction MS, and a direction represented by T1→T2 is a sub-scanning direction SS. In addition, scanning is performed in the main scanning direction, that is, in a direction of either the arrow S1 or the arrow S2 in one scan.

A cartridge 12 that supplies each ink to the ink jet head 2 includes a plurality of independent cartridges. The cartridge 12 is detachably mounted on the carriage 9 in which the ink jet head 2 is mounted. Each of the plurality of the cartridges is filled with different types of inks, and the ink is supplied to each nozzle from the cartridges 12. In the present embodiment, an example in which the cartridge 12 is mounted on the carriage 9 is shown, but the cartridge 12 is not limited to this, and may be in the form of being provided on a site other than the carriage 9 and supplied to each nozzle through a supply pipe not shown in the figure.

A method known in the related art can be used for ejecting of the ink jet head 2. In the present embodiment, a method of ejecting droplets by using vibration of a piezoelectric element, that is, an ejection method of forming ink droplets by mechanical deformation of an electrostrictive element is used.

The ink jet recording device 1 includes the ventilation fan 8, the IR heater 3, and the platen heater 4 for drying the ink ejected from the ink jet head 2 and adhered to the recording medium M. The primary drying step can be performed by appropriately using these ventilation fan 8, the IR heater 3, and the platen heater 4 in combination. In the primary drying step, it is not always necessary to heat the recording medium M, and the ventilation fan 8 may be used alone for carrying out the normal temperature air blowing.

When the IR heater 3 is used, the recording medium M can be radially heated by infrared radiation from the ink jet head 2 side. Due to this, the ink jet head 2 is also likely to be heated at the same time, but the temperature can be raised without being affected by a thickness of the recording medium M as compared with the case of being heated from a back surface of the recording medium M such as the platen heater 4. In addition, there may be provided various fans (for example, ventilation fan 8), which blow warm air or air having the same temperature as the environment to the recording medium M to dry the ink on the recording medium M.

The platen heater 4 can heat the recording medium M at a position facing the ink jet head 2 through the platen 11 so that the ink ejected by the ink jet head 2 can be dried early from a time when being adhered to the recording medium M. The platen heater 4 can heat the recording medium the M in a conductive manner, and the ink or the like can be attached to the recording medium M heated in this manner.

The surface temperature of the recording medium M due to the heating of the IR heater 3 and the platen heater 4 is preferably in the range described in the above-mentioned primary drying step.

The heating heater 5 is a heater for drying and solidifying the ink adhering to the recording medium M, that is, a heater for secondary drying. The heating heater 5 can be used in the secondary drying step. The heating heater 5 heats the recording medium M on which an image is recorded, so that moisture and the like contained in the ink are evaporated and scattered more quickly, and an ink film is formed by the resin particles that can be contained in the ink. In this way, the ink film is firmly fixed or adhered on the recording medium M to have excellent film-forming properties, and an excellent high-quality image can be obtained in a short time.

The surface temperature of the recording medium M due to the heating of the heating heater 5 is preferably in the range described in the above-mentioned secondary drying step. When the temperature is within the above range, there is a tendency that a high quality image is obtained in a short time.

The ink jet recording device 1 may include the cooling fan 6. After the ink recorded on the recording medium M is dried, the ink on the recording medium M is cooled by the cooling fan 6, so that an ink coating film can be made on the recording medium M with good adhesion property.

In addition, the ink jet recording device 1 may include a preheater 7 that preheats the recording medium M before the ink adheres to the recording medium M. In addition, the ink jet recording device 1 may include the ventilation fan 8 so that the ink adhered to the recording medium M is dried more efficiently.

Below the carriage 9, there are provided the platen 11 that supports the recording medium M, the carriage moving mechanism 13 that moves the carriage 9 relative to the recording medium M, and the transport unit 14 which is a roller that transports the recording medium M in the sub-scanning direction. Operations of the carriage moving mechanism 13 and the transport unit 14 are controlled by the controller CONT.

In another present embodiment, the ink jet recording device may be a line-type ink jet recording device in which the ink jet head 2 is a line head. For example, in FIG. 1, the ink jet head 2 is a line head having a length equal to or greater than the recording width in the width direction of the recording medium, and the position is fixed. The ink is ejected from the ink jet head 2 to the recording medium M being transported and adhered to the recording medium. In this case, recording is performed by one main scan. When the ink jet head 2 is a line head, the configuration other than the above may be the same as that in the serial type.

### 3. Example

Hereinafter, the present disclosure will be described in more detail with reference to examples, but the present disclosure is not limited to these examples. Hereinafter, “%” is based on mass unless otherwise specified.

### 3.1. Preparation of White Ink Composition and Non-White Ink Composition

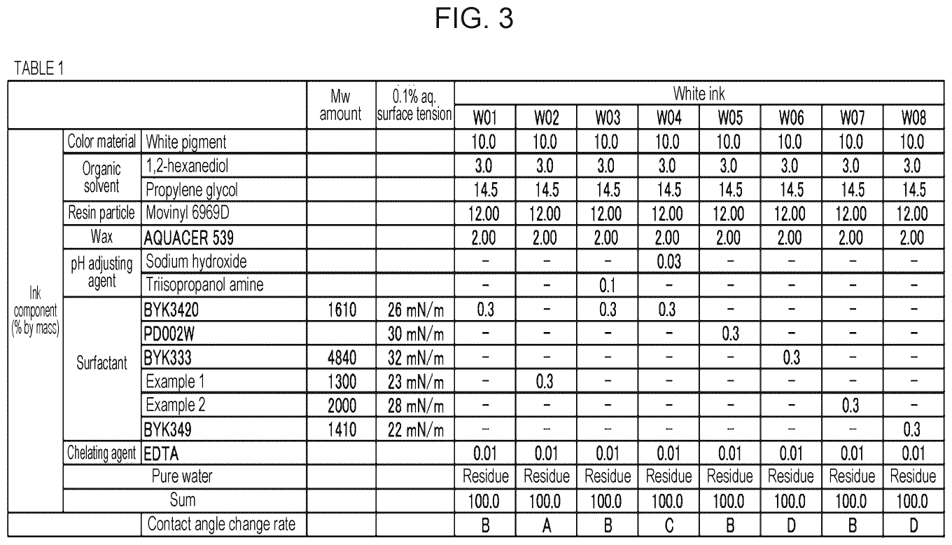

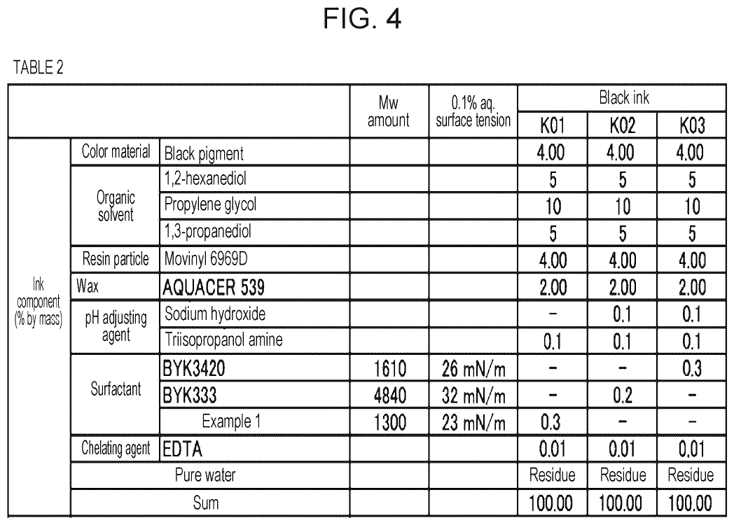

Each component is put in a container, so as to obtain the composition of Table 1 (FIG. 3) for the white ink composition, and to obtain the composition of Table 2 (FIG. 4) for the non-white ink composition, added with pure water so that a total amount of each composition is 100% by mass, mixed and stirred for 2 hours using a magnetic stirrer, then sufficiently mixed by performing dispersion treatment with a bead mill filled with zirconia beads having a diameter of 0.3 mm, and filtered using a 5 μm PTFE membrane filter when stirring for 1 hour to obtain each ink. The unit of numerical values in Tables 1 and 2 is % by mass.

As a white pigment (C.I. Pigment White 6, which is titanium dioxide) used for preparing the white ink composition, there is used a pigment dispersion liquid obtained by mixing 3 parts by mass of the white pigment with 1 part by mass of a dispersant and 10 parts by mass of ion-exchanged water, using a styrene-acrylic resin which can be synthesized by using 55% by mass of styrene, 20% by mass of acrylic acid, and 30% by mass of methyl methacrylate as the dispersant, premixing the obtained mixture, then dispersing thereof at a peripheral speed of 10 m/s and a liquid temperature of 30° C. for 15 minutes with zirconia beads having a diameter of 0.03 mm using a bead mill disperser (manufactured by Kusakabe Co., Ltd., UAM-015), and then centrifugally separating coarse particles using a centrifugal separator (manufactured by Kuboyama Shoji Co., Ltd., Model-3600).

As a black pigment used for preparing the non-white ink composition, “CAB-O-JET 300” (manufactured by Cabot Corporation, solid content 15%) which is a self-dispersing pigment is used.

In Tables 1 and 2, the column of the color material describes & by mass of the pigment converted from the solid content concentration. In addition, the column of the resin particles indicates a net addition amount of the solid content of the emulsion.

Surfactants of “Example 1” and “Example 2” described in Table 1 are synthesized as follows.

The surfactant of Formula (1) is synthesized using the compound of Formula (A) and the compound of Formula (B) described above.

Specifically, 5.8 g of a compound of Formula (A) in which b=7 and 0.1 mL of platinum chloride acid are added to a 20 mL tetrahydrofuran solution of 7.0 g of hexaethylene glycol monoaryl ether (in Formula (B), compound in which c is 6, R⁶ is an ethylene group, and R⁷ is a hydroxy group), and the mixture is held at 65° C. for 24 hours when stirring to react. After the reaction is completed, the solvent is removed by rotary evaporation to obtain a polyether-modified silicone-based surfactant (Example 1). Similarly, a polyether-modified silicone-based surfactant (Example 2) is obtained by changing b of Formula (A).

In the structure of the polyether-modified silicone-based surfactant (Example 1), in Formula (1), a=7, x and y=3, n and m=7, o and p=0, and R¹ and R²=hydroxy group.

In the structure of the polyether-modified silicone-based surfactant (Example 2), in Formula (1), a=17, x and y=3, n and m=7, o and p=0, and R¹ and R²=hydroxy group.

The description of the items in Tables 1 and 2 will be supplemented as follows.

### Resin Particles

Movinyl 6969D: (product name manufactured by Nippon Synthetic Chemical Industry Co., Ltd., acrylic resin emulsion, glass transition temperature 71° C.)

### Wax

AQUACER 539: (product name manufactured by BYK, paraffin wax)

### Surfactant

BYK3420: (Product name manufactured by Big Chemie Japan Co., Ltd., polyether-modified silicone-based surfactant having a weight average molecular weight Mw of 2,000 or less)
PD002W: “Orfin PD002W” (product name manufactured by Nisshin Chemical Industry Co., Ltd., acetylene glycol-based surfactant)·
BYK333: (Product name manufactured by Big Chemie Japan Co., Ltd., polyether-both-end-modified silicone-based surfactant)·
Example 1: (Polyether-both-end-modified silicone-based surfactant having a weight average molecular weight Mw of 2,000 or less)
Example 2: (Polyether-both-end-modified silicone-based surfactant having a weight average molecular weight Mw of 2,000 or less)
BYK 349: (Product name manufactured by Big Chemie Japan, polyether side chain-modified silicone-based surfactant)

A surface tension (0.1% aq. surface tension) of a 0.1% by mass aqueous solution of the surfactant is measured by confirming a surface tension when a platinum plate is wet with a 0.1% by mass aqueous solution of the surfactant in an environment of 20° C. using an automatic surface tension meter CBVP-Z (manufactured by Kyowa Interface Science Co., Ltd.)

### Chelating Agent

EDTA: (ethylenediaminetetraacetic acid)

Measurement conditions of the weight average molecular weight Mw by GPC in the surfactant are as follows.

### Measurement Conditions

Solvent: Tetrahydrofuran
Column: TSKgel SuperHZM-N×2
+ TSKgel guardcolumn SuperHZ-L
Column temperature: 40° C.
Pouring amount: 25 μL
Detector: Differential refraction (RI)
Flow rate: 0.35 mL/min
Calibration curve: Calibration curve using 13 samples of standard polystyrene STKstandard polystyrene (manufactured by Tosoh Corporation) Mw=1, 000,000 up to 500.

### 3.2 Printing Condition

A modified machine of “SC-R5050” (manufactured by Seiko Epson Corporation) was prepared as a printer, and each ink composition was filled in one nozzle row of the ink jet head. As the white ink composition and the non-white ink composition, those left to stand at room temperature for 12 months are filled.

As a head of the printer, a head having 360 nozzles, in which a nozzle density of nozzle row is 360 dpi.

In addition, the printer includes a platen heater and a delivery fan as a primary drying mechanism. Specifically, the printer includes a platen heater that performs primary drying at a position facing the ink jet head, and controls such that the surface temperature of the recording medium is 45° C. The wind speed is set to 2 m/s as the wind speed in the vicinity of the surface of the recording medium directly below the ink jet head. The wind temperature is measured in advance in the vicinity of the surface of the recording medium so as not to be affected by the platen heater, and is 25° C.

Furthermore, a secondary heater is provided downstream the printer, and the surface temperature of the recording medium is adjusted to 75° C. in the secondary drying.

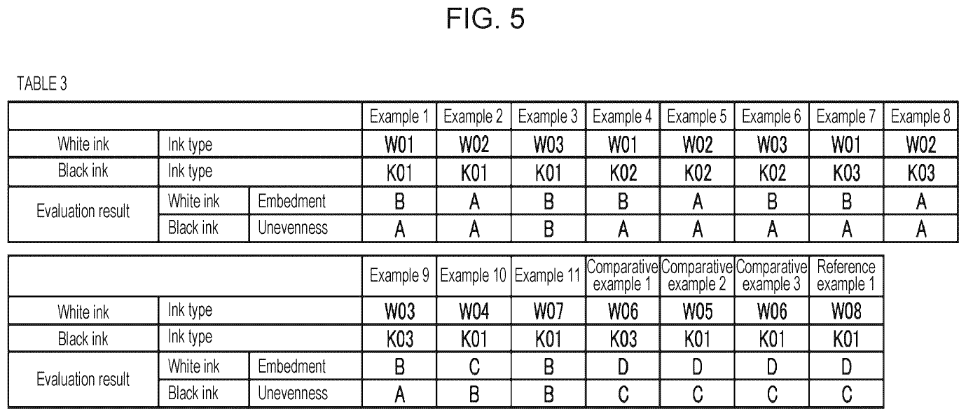

Using the printer configured as described above, recording is performed on PET50A (manufactured by Lintec, transparent PET film) with the ink combinations described in Table 3 (FIG. 5) at a recording resolution of 720×720 dpi, with a gradation pattern, an adhesion amount of the white ink composition of 13 mg/inch², an adhesion amount of the non-white ink composition of 7 mg/inch², and the number of passes in the adhesion step of each of the white ink composition and the non-white ink composition of 6 passes.

### 3.3. Evaluation Test

### 3.3.1 Contact Angle Change Rate

Contact angles of 5,000 ms with respect to PET50A (transparent PET film manufactured by LINTEC Corporation) for each of the initial ink of the white ink composition and the ink after being left to stand at room temperature (25° C.) for 12 months are measured using an “automatic contact angle meter DMo-902” (manufactured by Kyowa Interface Science Co., Ltd.), and are evaluated according to the following evaluation criteria based on the change rate obtained by the following formula. The surface tension of both the white ink composition and the non-white ink composition does not change after being left to stand at 25° C. for 12 months. On the other hand, there is an ink whose contact angle changes as described in the table.

$$Change rate ( \% ) = [ \text{} \{ ( 5 , 000 ms contact angle of ink left to stand at 25 ° C . for 12 months ) - ( 5 , 000 ms contact angle of initial ink ) \} \text{} / ( 5 , 000 ms contact angle of initial ink ) ] \times 100$$

### Evaluation Criteria

A: Change rate is less than 5%
B: Change rate is 5% or more and less than 10%
C: Change rate is 10% or more and less than 15%
D: Change rate is 15% or more

### 3.3.2 Embedment

A test pattern is recorded under the above printing conditions using only the white ink composition, it is confirmed whether or not the ground of the recording medium is visible in the printed matter, and evaluation of the embedment is performed according to the following evaluation criteria. Each ink uses an ink left to stand at room temperature (25° C.) for 12 months.

### Evaluation Criteria

A: The ink spreads sufficiently, and the ground of the recording medium cannot be visually confirmed or confirmed with a magnifying glass.
B: The ink spreads moderately, and the ground of the recording medium cannot be visually confirmed.
C: The ink spreads insufficiently, and the ground of the recording medium can be slightly visually confirmed.
D: The ink spreads insufficiently, and the ground of the recording medium can be visually confirmed and is noticeable.

### 3.3.3 Unevenness

Under the above printing conditions, a black ink pattern is recorded by being overlaid on the white ink pattern, a black ink pattern surface of the printed matter is observed, and it is determined whether or not unevenness occurs in the image according to the following evaluation criteria. Each ink uses an ink left to stand at room temperature (25° C.) for 12 months.

When the white ink is poorly embedded, unevenness occurs on the black ink surface to be recorded by being overlaid on the white ink. This is because a region where the white ink is poorly embedded is different from other regions in terms of the degree of wet spreadability of the black ink. The unevenness of the white ink is less noticeable, when the unevenness of the black (non-white) ink is more noticeable.

### Evaluation Criteria

A: The unevenness does not occur in the formed image.
B: Unevenness is not visually visible, but unevenness is visible with a magnifying glass.
C: The occurrence of unevenness can be visually confirmed.

### 3.4 Evaluation Results

The evaluation results are shown in Tables 1 and 3.

From the results described in Table 3, in all of the examples of an ink set which has the white ink composition containing the white color material and the non-white ink composition containing the non-white color material, and is used for recording on a low-absorptive recording medium or a non-absorptive recording medium, and in which the white ink composition and the non-white ink composition are aqueous ink jet inks, and the white ink composition contains a polyether-modified silicone-based surfactant having a weight average molecular weight Mw of 2,000 or less, it can be seen that the embedment of the white ink on the recording medium is favorable and the occurrence of unevenness in the color image (non-white image) can be reduced.

On the other hand, each of the comparative examples that do not satisfy the above configuration has inferior embedment and unevenness.

Although not shown in the table, when the evaluation of the embedment and unevenness is performed in the same method as the above-mentioned method using each of the white inks W01 to W08 and the black ink K01 in the same printing conditions, except that the ink before being left to stand at room temperature for 12 months is used, an example using W05 has a result in which embedment is D and unevenness is C, an example using W06 has a result in which embedment is B and unevenness is B, and other examples have a result in which embedment is A and unevenness is A.

In addition, although not described in the table, when the evaluation of embedment and unevenness is performed in the same method as the above-mentioned method, in the same printing conditions, except that the number of passes in each of the adhesion steps of the white ink composition and the non-white ink composition is set to one, the evaluation of embedment and unevenness has the same result as the case where the number of passes is six.

The following content is derived from the above-mentioned embodiment.

According to an aspect, there is provided an ink set including: a white ink composition containing a white color material; and a non-white ink composition containing a non-white color material, in which the ink set is used for recording on a low-absorptive recording medium or a non-absorptive recording medium, the white ink composition and the non-white ink composition are aqueous ink jet inks, and the white ink composition contains a polyether-modified silicone-based surfactant having a weight average molecular weight Mw of 2,000 or less.

In an aspect of the ink set, a contact angle change rate of the white ink composition with respect to polyethylene terephthalate, which is obtained by the following formula, may be less than 10%.

$$Contact angle change rate ( \% ) = \vert 5 , 000 ms contact angle of ink composition after being left to stand at 25 ° C . for 12 months - 5 , 000 ms contact angle of ink composition before being left to stand \vert \text{} / 5 , 000 ms contact angle of ink composition before being left to stand \times 100$$

In any aspect of the ink set, a surface tension of a 0.1% by mass aqueous solution of the polyether-modified silicone-based surfactant may be 28 mN/m or less.

In any aspect of the ink set, the white ink composition may have an alkali content of 0.18 by mass or less with respect to the total amount of the white ink composition.

In any aspect of the ink set, the white ink composition may have a content of inorganic alkali of less than 0.03% by mass with respect to a total amount of the white ink composition.

In any aspect of the ink set, a content of the polyether-modified silicone-based surfactant in the white ink composition may be 0.05% to 2.0% by mass with respect to a total amount of the white ink composition.

In any aspect of the ink set, the non-white ink composition may contain a polyether-modified silicone-based surfactant.

In any aspect of the ink set, the white ink composition and the non-white ink composition may contain an organic solvent.

According to another aspect, there is provided a recording method using the ink set of any of the above aspects, the recording method including: a white ink adhesion step of adhering the white ink composition to a recording medium by an ink jet method; and a non-white ink adhesion step of adhering the non-white ink composition to the recording medium by an ink jet method, in which the recording medium is a low-absorptive recording medium or a non-absorptive recording medium.

In an aspect of the recording method, the white ink adhesion step may include a primary drying step.

In any aspect of the recording method, the non-white ink adhesion step may be performed after the white ink adhesion step, and the white ink composition and the non-white ink composition may be adhered by being overlaid on the recording medium.

In any aspect of the recording method, the white ink adhesion step and the non-white ink adhesion step may be performed by scanning in which ink is ejected from the ink jet head and adhered to the recording medium when the ink jet head and the recording medium are being moved to a relative position, and a number of times of the scanning performed on the same scanning region on the recording medium may be one in the white ink adhesion step and may be one in the non-white ink adhesion step.

The present disclosure is not limited to the above-mentioned embodiment, and various modifications are possible. For example, the present disclosure includes a configuration substantially the same as the configuration described in the embodiment, for example, a configuration having the same function, method, and result, or a configuration having the same object and effect. In addition, the present disclosure also includes a configuration in which a non-essential part of the configuration described in the embodiment is replaced. In addition, the present disclosure includes a configuration that exhibits the same effects as the configuration described in the embodiment or a configuration that can achieve the same object. In addition, the present disclosure includes a configuration in which a known technique is added to the configuration described in the embodiment.

What is claimed is:

1. An ink set comprising:
a white ink composition containing a white color material; and
a non-white ink composition containing a non-white color material, wherein
the ink set is used for recording on a low-absorptive recording medium or a non-absorptive recording medium, the white ink composition and the non-white ink composition are aqueous ink jet inks, and
the white ink composition contains a polyether-modified silicone-based surfactant having a weight average molecular weight Mw of 2,000 or less.

2. The ink set according to claim 1, wherein
a contact angle change rate of the white ink composition with respect to polyethylene terephthalate, which is obtained by the following formula, is less than 10%,
$$contact angle change rate ( \% ) = \vert 5 , 000 ms contact angle of ink composition after being left to stand at 25 ° C . for 12 months - 5 , 000 ms contact angle of ink composition before being left to stand \vert \text{} / 5 , 000 ms contact angle of ink composition before being left to stand \times 100.$$

3. The ink set according to claim 1, wherein
a surface tension of a 0.18 by mass aqueous solution of the polyether-modified silicone-based surfactant is 28 mN/m or less.

4. The ink set according to claim 1, wherein
a content of alkali in the white ink composition is 0.1% by mass or less with respect to a total amount of the white ink composition.

5. The ink set according to claim 1, wherein
a content of inorganic alkali in the white ink composition is less than 0.03% by mass with respect to a total amount of the white ink composition.

6. The ink set according to claim 1, wherein
a content of the polyether-modified silicone-based surfactant in the white ink composition is 0.05% to 2.0% by mass with respect to a total amount of the white ink composition.

7. The ink set according to claim 1, wherein
the non-white ink composition contains a polyether-modified silicone-based surfactant.

8. The ink set according to claim 1, wherein
the white ink composition and the non-white ink composition contain an organic solvent.

9. A recording method performed using the ink set according to claim 1, comprising:
a white ink adhesion step of adhering the white ink composition to a recording medium by an ink jet method; and
a non-white ink adhesion step of adhering the non-white ink composition to the recording medium by the ink jet method, wherein
the recording medium is a low-absorptive recording medium or a non-absorptive recording medium.

10. The recording method according to claim 9, wherein
the white ink adhesion step includes a primary drying step.

11. The recording method according to claim 9, wherein
the non-white ink adhesion step is performed after the white ink adhesion step, and
the white ink composition and the non-white ink composition are adhered by being overlaid on the recording medium.

12. The recording method according to claim 9, wherein
the white ink adhesion step and the non-white ink adhesion step are performed by scanning in which ink is ejected from an ink jet head and adhered to the recording medium when the ink jet head and the recording medium are being moved to a relative position, and
the number of times of the scanning performed on the same scanning region on the recording medium is one in the white ink adhesion step and one in the non-white ink adhesion step.
